(19) United States
(12) Patent Application Publication
(10) Pub. No.: US 2014/0114969 A1
(43) Pub. Date: Apr. 24, 2014

(54) Building Dynamic Knowledge System Based on Instant Communications and Static Posts

(71) Applicants: David Sirbiladze, Campbell, CA (US); Johri Dhanotra, Los Altos, CA (US)

(72) Inventors: David Sirbiladze, Campbell, CA (US); Johri Dhanotra, Los Altos, CA (US)

(21) Appl. No.: 13/657,970

(22) Filed: Oct. 23, 2012

(51) Int. Cl. G06F 17/30

(52) U.S. Cl. CPC G06F 17/3061
USPC 707/736

(57) ABSTRACT

Allow enterprises to build a dynamic knowledge base in real time from instant communications within the company and with external entities. Index, and make searchable all communications based on texts within these communications, as well as tags that can be added in real time during instant messaging. Allow users to share all or parts of their instant message conversations with specific groups of people within, or outside of their enterprise.

### FIELD OF INVENTION

This invention is meant for the enterprise. Specifically, it facilitates communication between enterprises and their “extended family,” such as: external partners, support organizations, and other external entities. The goal is to catalog such communication in and out of the enterprise and make it easily accessible to promote better information access and use.

### BACKGROUND

In today's enterprise, the communication model is quickly changing. In the near past, phone conversations and faxes were sidelined by emails; emails are increasingly being replaced by instant message communication. More and more interactions are taking place via instant messaging, where valuable information is being shared between participants. While most platforms store instant message data in one form or another and allow for searching of this data, cataloging and sharing this data is not the primary focus of these solutions. As such, they lack key features such as tagging, and, more importantly the ability to share this information easily with people who could make use of it. This leads to lost time, to the incapability of finding relevant conversations, and further time consuming measures of sharing this data once found.

The goal of this invention is to store beneficial information in such a way that makes retrieving it easy, while also giving the user the ability to share his or her data with groups of other users, who will ultimately benefit from the exchange. It will help enterprises leverage the information that is generated by the exchanges their employees have between each other as well as external partners. The tagging function allows users to find a conversation by a word or phrase that was not mentioned in the conversation itself, but is relevant to the content stated in the conversation. For example, a support engineer who is speaking to a developer may tag a line in a conversation containing the solution to a problem with a word describing a problem type. This permits the conversation to be found by searching for the problem type, even though it was not mentioned in the conversation itself.

The ability to publish the conversation allows the above support engineer to share this solution with the rest of the support organization. The user can publish this conversation and select the group that defined the support organization to share it with. The individuals belonging to this group would thus be able to find this specific conversation by any word within the conversation or the tag word itself—in this case, the word or phrase describing the type of problem.

The same principle applies to tagging and sharing the tags of static posts and post comments within the application. This allows users to catalog this information for efficient retrieval by them, or others they feel will need this information.

### DESCRIPTION OF THE INVENTION

Ultimately, the invention has two parts—tagging and publishing. It applies to two mediums of communication—instant messages and posts.

For chats, there are two types of tags. The first allows a user to associate a word or phrase to a particular line in the instant message. This is done by double clicking on a line to select it, then right clicking on the selection and choosing the tag option from the right click menu. A dialog pops up asking a user to enter a word of phrase for the tag. This line is then tagged with the word(s) entered in the dialog box. Additionally, the second type of tag gives users the ability to tag an entire conversation. This is done by right-clicking the top bar of the chat box and selecting tag from the right click menu. A dialog box prompts the user for the word or phrase for the tag and associates the tag to the entire conversation.

When a user preforms a search that matches conversations by tag, these conversations are displayed in a search result list. If a user clicks on a result that was matched via a line tag, the conversation is opened and the user is automatically taken to the line in the conversation where the tag was placed. If a user clicks on a result that was matched via a conversation tag, the conversation is displayed from the beginning.

By default, only the users initially involved in the conversation are able to search the data via content and tags. A user must use the publish feature in order to make this information accessible by other people. This functionality is described later.

For posts, there are also two types of tags. A user can right click on either a post or a post comment, and then select the tag option. A dialogue box pops up, allowing the user to enter a word or phrase to tag the post or comment.

If a user preforms a search that matches a tag in the post and clicks on this result in the search results, the post is displayed with all the comment. If a user performs a search that matches a post comment, and then clicks this result in the search results, the entire post is displayed with the post comment matching the tag highlighted.

Publishing differs between the two communication mediums.

For chats, a user is able to publish a chat during a conversation, or at any later date. To publish a chat during, or right after the conversation, the user clicks a publish button displayed on the chat window.

Clicking this button opens up a full feature text editor, where the contents of the entire chat conversation are displayed. The user has the ability to modify the contents by adding or removing content, adding footnotes, or any other relevant information. The user can also add global conversation tags at this point for future searching. In this view, the user also selects groups of users to share the conversation with. Once the user clicks publish, the modified conversation is saved, and is searchable by any user belonging to any of the groups specified in the “share with” groups. If a user does not add any groups, the conversation will be shared with all users in the organization.

The user also has the ability to publish a conversation well after the conversation date. To do this, the user searches for the conversation, clicks on it in the search result to open it in the conversation view and clicks the available publish button. The rest of the workflow is the same as above.

For posts and post comments, a user can only publish a tag to the entirety or a subset of users that can view the post as defined by the posts sharing groups.

1) a method for tagging a line in an instant communication message: A user right clicks in the window, selects tag, and adds a tag for future searching. The conversation is later searchable by the word in the tag even though the word did not show up in the conversation itself.

2) When a conversation is found by searching for a tag word, and the user clicks on the search result, the conversation is displayed centered around the message where the tag was placed. Therefore, if the tag was placed in the middle of the conversation, the chat display window will be scrolled to the precise location of the tag.

3) In addition to inline-tagging, there is a concept of global tagging. When a user right clicks on the top of the chat window, he's given a dialog to add 1 or more tags. The conversation is searchable by these tags; however, the search results are displayed from the beginning rather than at a specific spot, as stated in the previous claim.

4) By default, the conversations are searchable only by the people in the conversation. To ease sharing of information is the introduction of the ability to publish conversations. The top of the chat window contains a publish button. When clicking the publish button, the user is presented with a text editor. In this window, the user can choose to edit the conversation, such as removing certain portions of text, or adding foot notes. This window has two other functions. There is a text area to add global tags, as defined in claim 4, and a “share with” text box to add groups of users to share the conversation with. Groups are defined by the user in another part of the application and consist of a name and a list of users associated with the organization. The users in the groups mentioned in the “share with” dialogue will now be able to search for this conversation by either the content in the conversation itself, or any tags associated with the conversation.

5) The product also has posting functionality. Users can post updates seen by other users in specified groups. This claim is to allow for tagging of posts, or post comments for searching.

6) Allow the publishing of post and post comment tags. Once a post (or post comment) is tagged, the tag can be published to a group or list of groups, just as chat conversations in claim 4. Once published, users in the groups the tag was shared with can find these posts by the text in the tag as well as the text in the post itself.
